(19) United States
(12) Patent Application Publication
(10) Pub. No.: US 2014/0367048 A1
(43) Pub. Date: Dec. 18, 2014

(54) Mechanical assembly for urging the circumferential segments of a tire-building drum into fully-expanded positions

(71) Applicant: Mark S. Byerley, Greenback, TN (US)

(72) Inventor: Mark S. Byerley, Greenback, TN (US)

(73) Assignee: BPS Engineering, LLC, Greenback, TN (US)

(21) Appl. No.: 14/120,088

(22) Filed: May 12, 2014

Related U.S. Application Data
(60) Provisional application No. 61/957,916, filed on Jul. 15, 2013.

(51) Int. Cl. B29D 30/26

(52) U.S. Cl. CPC B29D 30/26; B29D 2030/2642; B29D 2030/2657
USPC 156/417

(57) ABSTRACT

A tire-building drum having a hollow main shaft and a swing arm rotatably positioned about the main shaft for moving the circumferential surface-defining segments of the drum between collapsed positions and fully-expanded positions as the swing arm is rotatably moved about the swing arm from a first angular position thereabout to a second angular position thereabout includes a mechanical assembly for acting between the swing arm and the main shaft so that upon rotation of the swing arm about the main shaft to its second position thereabout, the mechanical assembly biases the swing arm about the main shaft to continually urge the circumferential segments into the fully-expanded positions.

The benefit of Provisional Application Ser. No. 61/957,916, filed Jul. 15, 2013 and entitled MECHANICAL ASSEMBLY FOR MAINTAINING OUTWARDLY-DIRECTED PRESSURE ON THE CIRCUMFERENTIAL SEGMENTS OF A TIRE-BUILDING DRUM, is hereby claimed. The disclosure of that referenced provisional application is incorporated herein by reference.

### BACKGROUND OF THE INVENTION

This invention relates generally to a radially-expandable tire-building drum having circumferential segments which define a circumferential surface of the drum and relates, more particularly, to the means and methods by which the circumferential segments of such a drum are moved between collapsed positions at which the drum is in a collapsed condition and fully-expanded positions at which the drum is in a fully-expanded condition.

The class of tire-building drums with which this invention is concerned includes those having circumferential surface-defining segments which are moved between collapsed positions (for removal of a constructed tire carcass from the drum) and fully-expanded positions (at which a tire carcass can be constructed about the drum) as a drive rod is moved axially along a hollow main shaft of the drum between alternative, i.e. retracted and extended, axial positions. Connected between the drive rod and the circumferential segments are interlinking components (including, for example, a main shaft, a swing arm which encircles the main shaft and can be rotated relative to the main shaft between alternative positions thereabout and transition elements joined between the swing arm and the circumferential segments) which effect the movement of the circumferential segments between the collapsed and expanded conditions as the drive rod is moved axially along the main shaft between the retracted and extended positions. One end of the main shaft is connected to a support from which the tire-building drum is cantilevered above a floor, and a pneumatic (e.g. air-powered) actuating mechanism is associated with the support and is connectable to the drive rod for moving the drive rod axially of the main shaft and between alternative axial (i.e. retracted and extended) positions.

Through the use of pressurized gas (e.g. air), the drive rod is moved (by way of the pneumatic actuating mechanism) from its retracted position to its extended position so that the circumferential segments are moved to the fully-expanded positions, and as long as axial pressure is maintained upon the drive rod while in its extended position, the circumferential segments are maintained in a relatively tight-fitting relationship with one another—and consequently in the fully-expanded positions, for construction of a tire carcass about the drum. If, however, axial pressure is relieved from the drive rod when the drive rod is in its extended position (by, for example, relieving the pneumatic pressure upon the actuating mechanism—and as may be desired for safety-related purposes), the circumferential segments tend to back off of the tight-fitting relationship with one another to a less-desirable condition for construction of a tire carcass about the drum. Furthermore, the magnitude of such a backing off of the circumferential segments is magnified if the interlocking components become worn over time.

It would be desirable to provide a cost effective and reliable scheme for urging the circumferential segments to the fully-expanded positions after the axial pressure which has been exerted upon the drive rod by the pneumatically-powered actuating mechanism to move the segments to the fully-expanded positions has been relieved to thereby maintain the circumferential segments of the drum in a tight-fitting relationship with one another for use of the drum.

Accordingly, it is an object of the present invention to provide a new and improved scheme for continually urging the circumferential segments of the drum to the fully-expanded positions and thus into a tight-fitting relationship with one another after the air pressure which has been used to move the segments to the expanded condition is relieved.

Another object of the present invention is to provide such a scheme which is well-suited for maintaining the circumferential segments in a tight-fitting relationship with one another when in the fully-expanded positions even after internal components of the drum become so worn that the maintaining of the segments in a tight-fitting relationship with one another would otherwise be difficult to maintain.

Still another object of the present invention is to provide such a scheme wherein the forces which are employed for continually urging the circumferential segments into the fully-expanded positions are not employed before the segments have been moved to positions which approach the fully-expanded positions.

Yet another object of the present invention is to provide such a scheme which is adapted to act between the swing arm and the main shaft upon rotation of the swing arm relative to the main shaft to a position at which the drum approaches its fully-expanded condition.

A further object of the present invention is to provide such a scheme whose components can be readily replaced if desired.

A still further object of the present invention is to provide such a scheme which is uncomplicated in structure, yet effective in operation.

### SUMMARY OF THE INVENTION

This invention resides in an improvement in a tire-building drum having a hollow main shaft having an end which is mountable upon a support for supporting the drum in a cantilevered condition above a floor, a plurality of circumferential segments about which a tire carcass can be constructed and which are movable between collapsed positions at which the drum is in a radially-collapsed condition and fully-expanded positions at which the drum is in a radially and fully-expanded condition, a drive rod which is positioned within and is axially movable along the length of the main shaft between a first condition and a second condition and means for moving the drive rod along the main shaft between the first and second conditions, and a swing arm which surrounds the main shaft and is connected between the circumferential segments and the drive rod so that axial movement of the drive rod along the length of the main shaft from the first condition to the second condition effects a rotation of the swing arm about the main shaft from a first position thereabout at which the drum is in its radially-collapsed condition to a second position at which the drum is in its radially and fully-expanded condition.

The improvement includes a mechanical assembly for acting between the swing arm and the main shaft so that upon rotation of the swing arm about the main shaft to its second position thereabout, the mechanical assembly biases the swing arm about the main shaft to continually urge the circumferential segments into the fully-expanded positions.

### BRIEF DESCRIPTION OF THE DRAWINGS

FIG. 1 is a perspective view of an embodiment of a tire-building drum within which features of the present invention are embodied and showing the circumferential segments of the drum when the drum is positioned in its fully-expanded condition.

FIG. 2 is a view of the FIG. 1 drum showing the circumferential segments of the drum when the drum is positioned in its collapsed condition.

FIG. 3 is an end view of internal componentry, including the main shaft and the swing arm positioned about the main shaft, of the FIG. 1 drum taken about along line 3-3 of FIG. 1.

FIG. 4 is a longitudinal cross sectional view of the drum componentry of FIG. 3 taken along line 4-4 of FIG. 3.

FIG. 5 is a schematic perspective view of fragments of the main shaft and swing arm of the FIG. 1 drum, shown exploded and illustrating the positional relationship between the swing arm and the main shaft when the drum is in its FIG. 2 collapsed condition.

FIG. 6 is a view similar to that of FIG. 5 but illustrating the positional relationship between the swing arm and the main shaft when the drum is in its FIG. 1 fully-expanded condition.

FIG. 7 is a view of a fragment of the cross-sectional view of FIG. 4, but drawn to a slightly larger scale and illustrating a mechanical assembly of the FIG. 1 drum used to continually bias the circumferential segments toward the FIG. 1 fully-expanded positions.

FIG. 8 is a view of the components of the mechanical assembly of FIG. 7, shown exploded.

FIG. 9 is a view of another fragment of the cross-sectional view of FIG. 4, shown exploded.

FIG. 10 is a top plan view of a plug component of the FIG. 1 drum, as seen generally from above in FIG. 9.

FIG. 11 is a cross-sectional view taken along line 11-11 of FIG. 7.

FIG. 12 is a schematic view similar to that of FIG. 11 within which spring-induced force vectors which act upon the main shaft by the mechanical assembly of FIG. 1 are depicted.

FIG. 13 is a perspective view of an alternative plug against which a poppet assembly of the FIG. 1 drum can act.

FIG. 14 is a cross-sectional view similar to that of FIG. 11 but illustrating a mechanical assembly which utilizes the FIG. 13 plug.

FIG. 15 is a cross-sectional view similar to that of FIG. 11 but illustrating an alternative mechanical assembly which can be employed within the FIG. 1 drum.

### DETAILED DESCRIPTION OF AN ILLUSTRATIVE EMBODIMENT

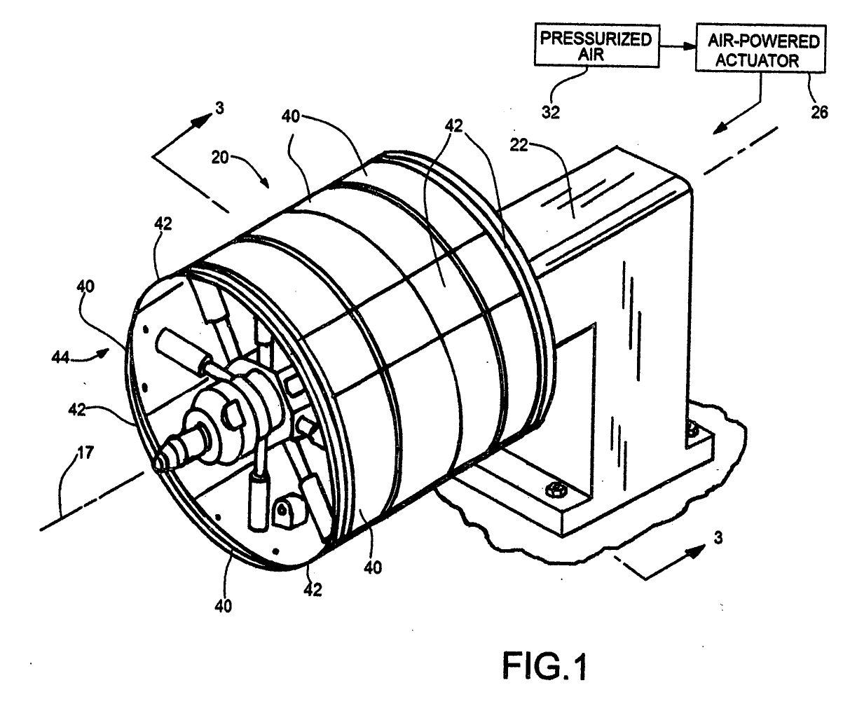

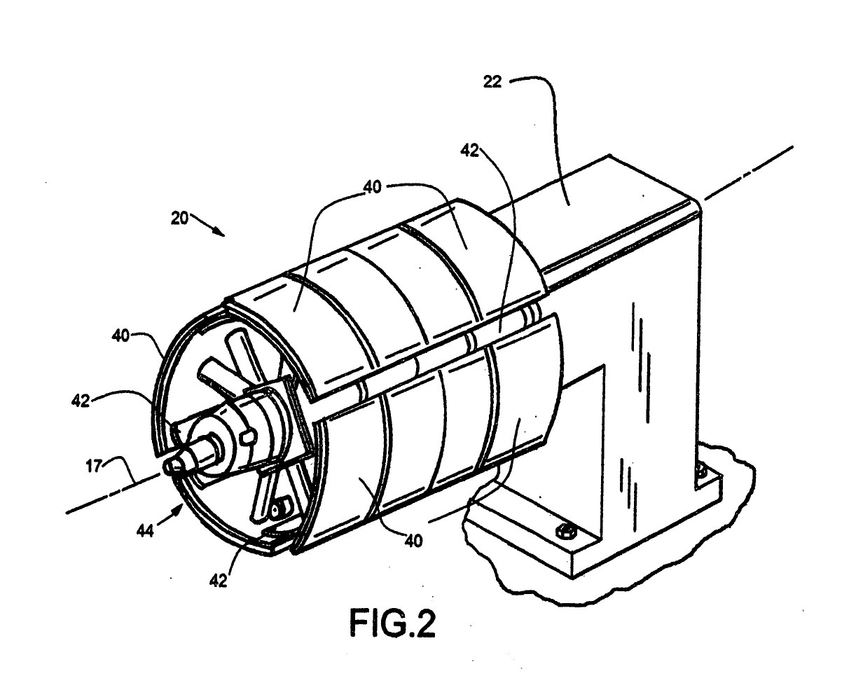

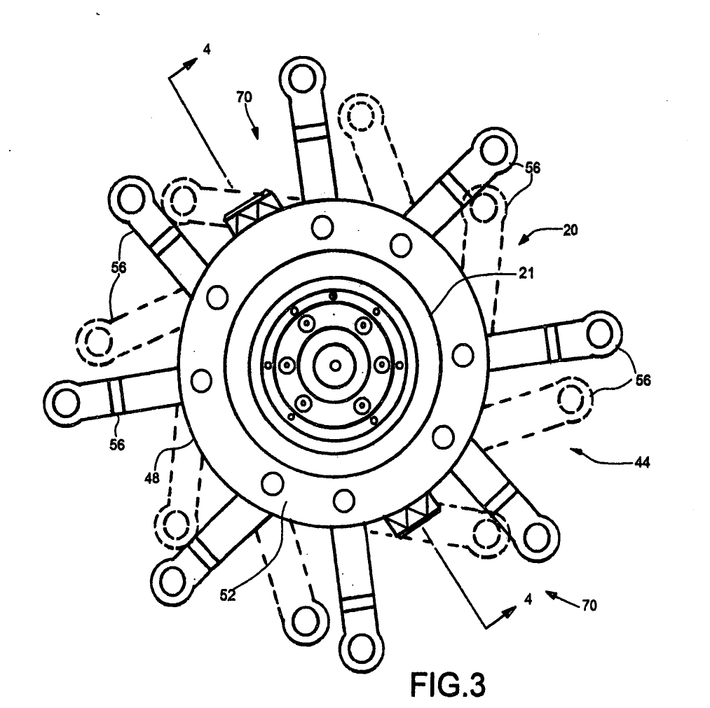

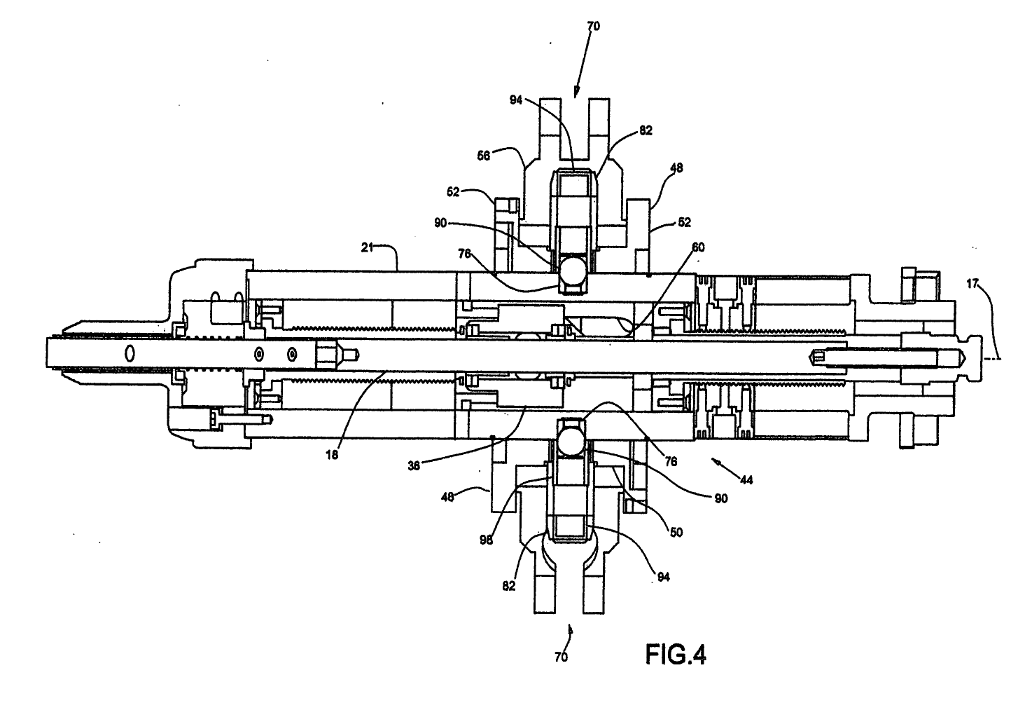

Turning now to the drawings in greater detail and considering first FIGS. 1-4, there is schematically illustrated an embodiment, generally indicated 20, of a tire-building drum having a main shaft 21 (FIGS. 3 and 4) shown mounted to a suitable support 22 (FIGS. 1 and 2) so that the drum 20 is arranged in a cantilevered condition above a floor for use of the drum 20. Associated with one end (i.e. a supported end) 34 of the main shaft 21 is a flange 24 (FIG. 4) which is used to mount the main shaft 21 (and thus the drum 20) to the support 22 and pneumatic (i.e. air-powered) actuating means, indicated 26 in FIG. 1, for moving a drive rod 18 (FIG. 4) of the tire-building drum 20 axially along the length of the main shaft 21. Within the depicted drum 20, the longitudinal centerline of each of the drive rod 18 and main shaft 21 provides the longitudinal axis, or centerline, 17 of the drum 20.

For use with the depicted drum 20, the pneumatic actuating means 26 is air-powered, and as is known in the art, includes a push-pull rod, or ram, and an associated air cylinder within which the push-pull rod is slidably positioned. The air cylinder is mounted in such a relation to the support 22 that the push-pull rod is capable of moving axially (i.e. horizontally as viewed in FIG. 4) along the length of the main shaft 21 of the drum 20 between a retracted (i.e. a first) condition and an extended (i.e. second) condition. The push-pull rod is, in turn, connected to the drive rod 18 for axially moving the drive rod 20 relative to and along the length of the main shaft 20 between a retracted (i.e. first) condition relative to the main shaft 21 and an extended (i.e. second) condition relative to the main shaft 21. The air cylinder of the pneumatic actuating means 26 receives air from a source, indicated 32 in FIG. 1, of air under pressure and is preferably a double-acting air cylinder in that chambers within the air cylinder are adapted to accept air for forcibly urging the push-pull rod (and thus the drive rod 48) toward either of its extended condition or its retracted condition, depending upon the desires of the drum operator.

Much of the structure and componentry of the tire-building drum 20 are known so that a greatly detailed description of the drum 20 is not believed to be necessary. Suffice it to say that positioned about the drum 20 are a plurality of circumferential surface-defining segments 40, 42 which are movable between fully-expanded positions (which correspond to the FIG. 1 radially and fully-expanded condition of the drum 20) at which a tire carcass can be constructed about the drum 20 and fully-collapsed positions (which correspond to the FIG. 2 radially and fully-collapsed condition of the drum 20) at which a constructed tire carcass can be removed from the drum 20. Furthermore, the drum 20 includes an assemblage of componentry, indicated generally 44 in FIGS. 3 and 4, interposed between the drive rod 18 and the circumferential segments 40, 42 so that by shifting the drive rod 18 axially with respect to the main shaft 21 from a retracted position to an extended position, the circumferential segments 40, 42 are moved from the collapsed positions of FIG. 2 to the fully-expanded positions of FIG. 1. Conversely and by shifting the drive rod 18 axially with respect to the main shaft 21 from the extended position to a retracted position, the circumferential segments 40, 42 are moved from the fully-expanded positions of FIG. 1 to the fully-collapsed positions of FIG. 2.

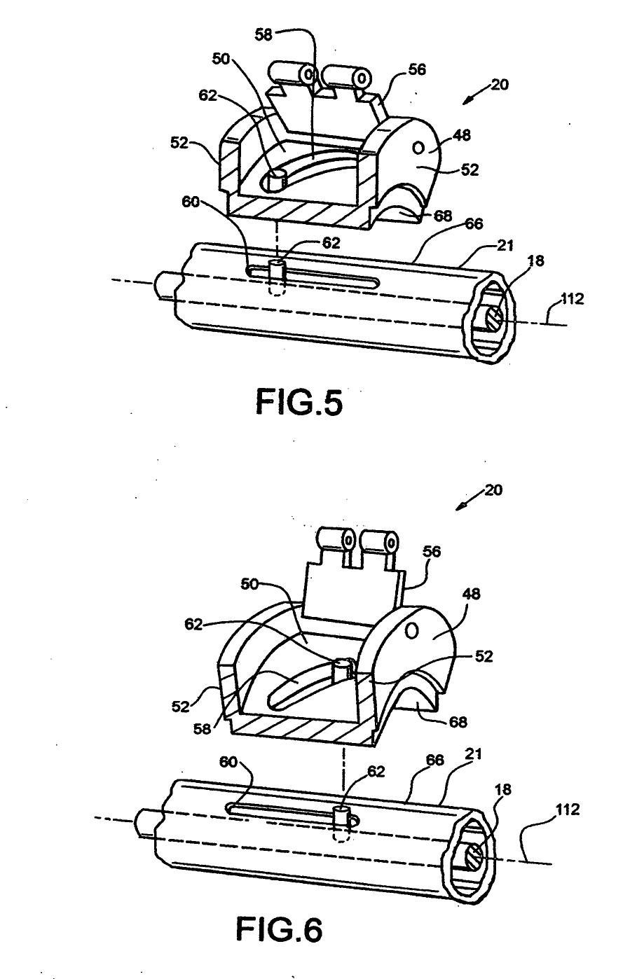

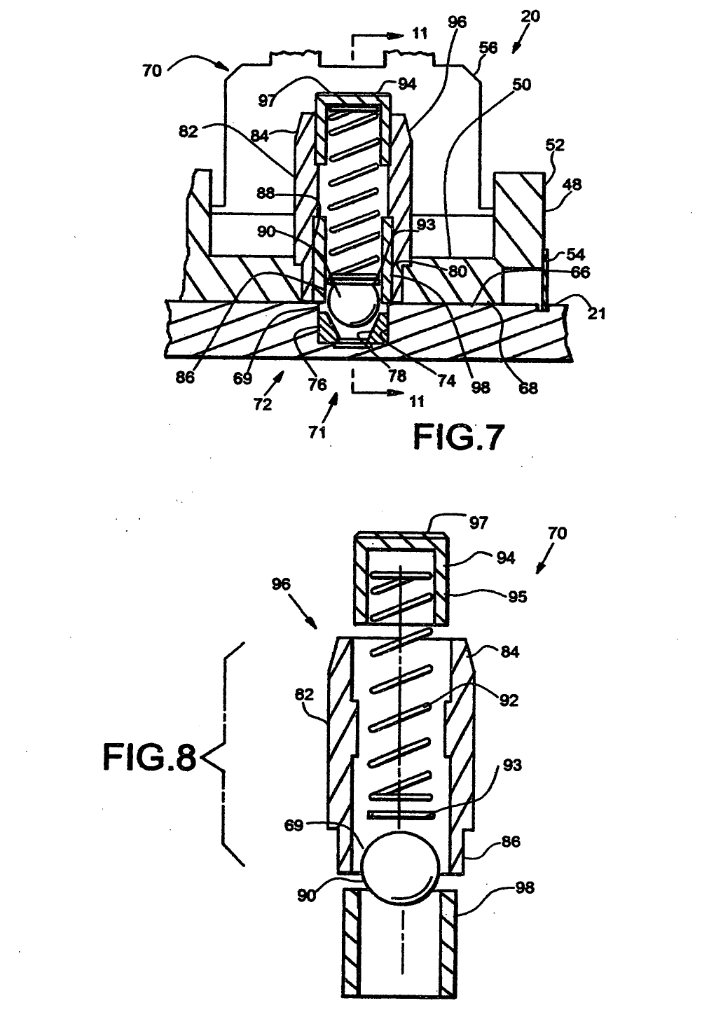

With reference to FIGS. 3-7, the componentry 44 includes a spool-shaped swing arm 48 having a hollow cylindrical central body portion 50 which encircles the main shaft 21 and further has radial flanges 52 which are disposed at the opposite ends of the central body portion 50. The swing arm 48 is rotatable about the main shaft 21 but is restrained against axial movement therealong by retainer members 54 (only one shown in FIG. 7) disposed outboard of the end radial flanges 52. In addition, there are provided links 56 which are disposed between the end radial flanges 52 and which are each pivotally connected between the circumferential segments 40 or 42 and the end radial flanges 52 so that upon rotation of the swing arm 48 about the main shaft 21 through, for example, about eighty degrees of movement thereabout, the links 56 shift between a collapsed condition (as depicted in phantom in FIG. 3 and in solid lines in FIG. 5) at which the drum 20 is in its FIG. 2 radially-collapsed condition and a substantially radially-extending condition (as depicted in solid lines in FIG. 3 and in FIG. 6) at which the drum 20 is in its FIG. 1 fully-expanded condition.

With reference again to FIG. 4, there is interposed between the drive rod 18 and the main shaft 21 a collar member 36 which is positioned about the drive rod 18 for axial movement (with the drive rod 18) relative to and along the main shaft 21 and there is mounted within the collar member 26 a pair of roller cams 62 (only one shown in FIGS. 5 and 6) which extend axially of the collar member 36 from opposite sides thereof. Meanwhile and with reference to FIGS. 4-6, the central body portion 50 of the swing arm 48 is provided with a pair of helical slots 58 (only one shown in FIGS. 5 and 6) which are disposed on diametrically-opposed sides thereof, and the main shaft 21 (which is rigidly restrained against rotation by the support 22) is provided with a pair of elongated slots 60 (only one shown in FIGS. 5 and 6) which are disposed on diametrically-opposed sides of the main shaft 21 and which extend along the length thereof.

Each of the aforementioned roller cams 62 (only one shown in FIGS. 5 and 6) are each accepted by a corresponding elongated linear slot 60 of the main shaft 21 and a helical slot 58 of the swing arm 48. Therefore and as best shown in FIGS. 5 and 6, there exists an aligned relationship between each roller cam 62, a corresponding elongated slot 60 of the main shaft 21 and a corresponding helical slot 58 of the swing arm 48. As the drive rod 18 is moved axially, or longitudinally, along the drum 20, each roller cam 62 is moved linearly along the drum 20 in conjunction with the movement of the drive rod 18 axially along the main shaft 21 as the roller cam 62 is confined to linear movement along an elongated slot 60 of the main shaft 21.

At the same time, the acceptance of the roller cam 62 by a corresponding helical slot 58 of the swing arm 48 effects the rotation of the swing arm 48 about the main shaft 21 as the roller cams 62 are urged linearly along the elongated slots 60 of the main shaft 21 with the drive rod 18. In other words and because the roller cams 62 are accepted by both the elongated slots 60 of the main shaft 21 and the helical slots 58 of the swing arm 48, the linear movement of the roller cams 62 along the length of the main shaft 21 (in response to the movement of the drive rod 18 axially along and through the main shaft 21) forces the swing arm 48 to rotate about the main shaft 21 so that the links 56, in turn, are pivoted relative to the swing arm 48 so as to move the circumferential segments 40, 42 between the FIG. 1 fully-expanded positions and the FIG. 2 fully collapsed positions.

In connection with the foregoing, the swing arm 48 is rotated (by way of the axial movement of the drive rod 18 along the main shaft 21) between a first angular position (depicted in FIG. 5) about the main shaft 21 at which the links 56 are disposed in a collapsed condition relative to the swing arm 48 to thereby position the circumferential segments 40, 42 in the FIG. 2 fully-collapsed positions and a second angular position (depicted in FIG. 6) at which the links 56 extend substantially radially of the swing arm 48 to thereby position the circumferential segments 40, 42 in the FIG. 1 fully-expanded position. In addition, the circumferential segments 40, 42 are adapted to move into an abutting, and thus tight-fitting, relationship with one another when moved into the fully-expanded positions and thus establish the second angular position (corresponding to one of the, i.e. the forwardmost) radial limit of travel of the swing arm 48 about the main shaft 21. In other words, rather than the linear slots 60 or the helical slots 58 establishing the second angular position of the swing arm 48 about the main shaft 21, it is the angular position of the swing arm 48 relative to and about the main shaft 21 at the movement that the circumferential segments 40, 42 move into the fully-expanded positions that establishes the second angular position, or the forwardmost position, of the swing arm 48 about the main shaft 21.

It will be understood from the foregoing that the main shaft 21 has an outer surface 66 which faces radially outwardly, and the swing arm 48 or, more specifically, the central body portion 50 thereof, has an inner surface 68 which encircles and faces the outer surface 66 of the main shaft 21. It will also be understood that as the swing arm 48 is rotated relative to and about the main shaft 21 between its first (FIG. 5) angular position and its second (FIG. 6) angular position, the inner surface 68 of the swing arm 48 moves, or rotates, relative to and about the outer surface 66 of the main shaft 21.

With reference to FIGS. 3-8, it is a feature of the present invention that the tire-building drum 20 includes means, generally indicated 69, in the form of a pair of mechanical assemblies, each of which is generally indicated 70 in FIGS. 3, 4, 7 and 8, for acting between the swing arm 48 and the main shaft 21 so that upon movement of the swing arm 48 relative to and about the main shaft 21 into the aforedescribed second angular position about the main shaft 21, the circumferential segments 40, 42 are continually urged into the fully-expanded positions so that so that even after the force (i.e. the air pressure) which has been used to expand the drum 20 from its FIG. 2 collapsed condition to its FIG. 1 fully-expanded condition is relieved, the circumferential segments 40, 42 remain solidly in the FIG. 1 fully-expanded positions.

In connection with the foregoing, the mechanical assemblies 70 are mounted within the mounted within the central body portion 50 of the swing arm 48 at diametrically-opposed locations thereon and are adapted to act between the swing arm 48 and the main shaft 21 so that upon approach of the swing arm 48 to its second angular position about the main shaft 21, the swing arm 48 continues to be urged radially about the main shaft 21 in a direction which corresponds with the direction of movement of the swing arm 48 from its first angular (FIG. 5) position about the main shaft 21 toward its second angular (FIG. 6) position about the main shaft 21. In other words, upon rotation of the swing arm 48 about the main shaft 21 to the second angular position thereabout, the mechanical assemblies 70 continue to urge the swing arm 48 to rotate in this same (i.e. forward) rotational direction about the main shaft 21 and thus beyond its forwardmost radial limit of travel about the main shaft 21. It therefore follows that by urging the swing arm 48 to rotate forwardly about the main shaft 21 beyond the forwardmost radial limit of travel (i.e. beyond the second angular position of the swing arm 48 about the main shaft 21), the circumferential segments 40, 42 of the drum 20 are continually biased into the fully-expanded (FIG. 1) positions.

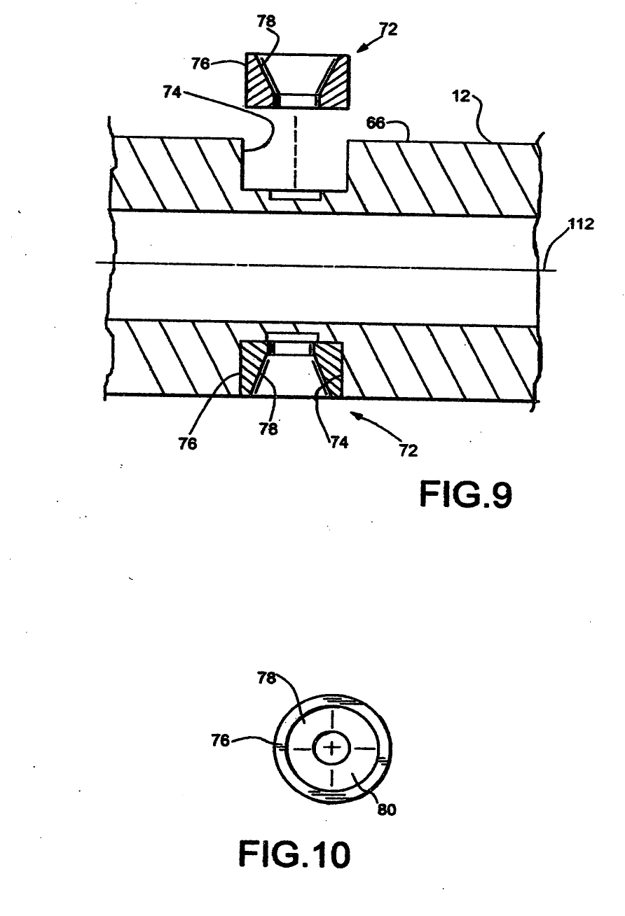

With reference to FIGS. 7-11 and within the depicted drum 20, each mechanical assembly 70 is mounted within the central body portion 50 of the swing arm 48 so that biasing forces which are generated within the mechanical assemblies 70 (in a manner described herein) are urged against the main shaft 21 at locations disposed adjacent the outer surface 66 of the main shaft 21. In this connection and as will be apparent herein, these biasing forces include tangentially-directed force components which urge the swing arm 48 to rotate relative to and about the main shaft 21 beyond the forwardmost limit of travel of the swing arm 48 and in a direction about the swing arm 48 (i.e. a forwardly direction) which corresponds with the direction of movement of the swing arm 48 from the first angular position toward the second angular position.

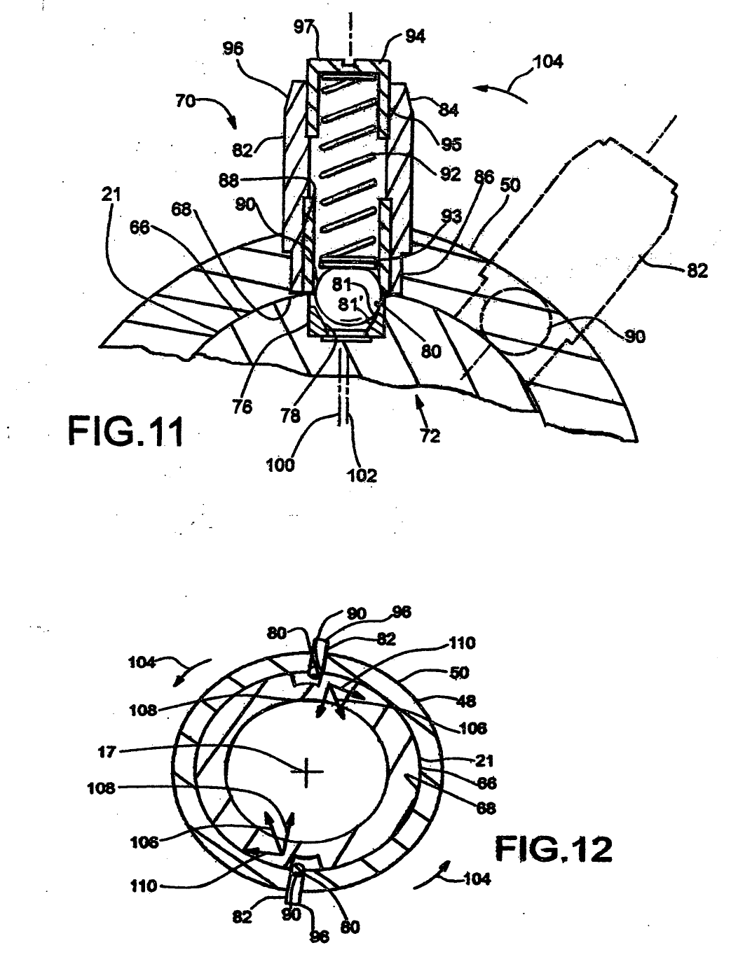

Within the depicted drum 20, the main shaft 21 is provided with means, generally indicated 71, for providing a pair of detents, indicated 72, adjacent the outer surface 66 of the main shaft 21, and it is these detents 72 or, more specifically, the engagement surfaces 80 (FIG. 11) thereof, that the biasing forces which are generated by the mechanical assemblies 70 are adapted to act. In this connection, the pair of mechanical assemblies 70 are mounted within the swing arm 48 and on diametrically-opposite sides of the longitudinal axis 17 of the drum 20 (best shown in FIG. 4), and the detents 72 of the detent-providing means 71 are disposed adjacent the outer surface 66 of the main shaft 21 at locations therealong and on diametrically-opposed sides of the longitudinal axis 17 of the drum 20 so that each detent 72 is adapted to cooperate with a corresponding mechanical assembly 70. In addition, each mechanical assembly 70 is in such a positional relationship with respect to the detent 72 with which it is adapted to act so that when the swing arm 48 has been rotated about the main shaft 21 to its second angular position, the mechanical assemblies 70 cooperate with the provided detents 72 to urge the swing arm 48 to rotate forwardly of the main shaft 21 beyond its forwardmost radial limit of travel (i.e. its second angular position) about the main shaft 21.

Within the depicted drum 20 and as best shown in FIGS. 4, 9 and 10, the detent-providing means 71 includes a pair of plugs 76 which are threadably accepted by a pair of internally-threaded openings 74 which have been formed within the outer surface 66 of the main shaft 21. Each plug 76 has a body within which a conically-shaped indentation 78 has been formed, and each indentation 78 is provided with the earlier-mentioned engagement surface 80 (best shown in FIG. 11) along an interior surface thereof, and as mentioned earlier, it is this engagement surface 80 which is adapted to be acted directly upon by a corresponding one of the mechanical assemblies 70.

With reference again to FIG. 7, each mechanical assembly 70 includes a poppet assembly 96 which cooperates with the indentation of a corresponding plug 76 in a manner that urges the swing arm 48 to rotate (i.e. forwardly) beyond between the ball 90 and the underside of the head 97 of the cap member 94. By positioning the flat washer 93 between the surface of the ball 93 and the (lower) end of the spring 92, the (lower) end of the spring 92 is less likely to be spread apart, or become enlarged in diameter, as the spring 92 acts against the ball 93.

The exterior face of the head 97 of the cap member 94 is appropriately slotted to accept the end of a screwdriver (not shown) or some other tool to facilitate the rotation of the cap member 94 within the barrel 82. Each poppet assembly 96 also includes an inner sleeve member 98 which is force-fitted within the barrel end 86 to help confine the (upwardly or downwardly, as viewed in FIGS. 7 and 8) movement of the ball 90 along the longitudinal axis of the barrel 82. When mounted within the barrel 82 of a corresponding assembled poppet assembly 96 and as depicted in FIGS. 7, 8 and 11, the ball 90 is disposed adjacent the outer surface 66 of the main shaft 21 and the compression spring 92 is disposed between the ball 90 and the head 97 of the cap member 94 so that the spring 92 urges the ball 90 toward the main shaft 21.

In order for the mechanical assemblies 70 to cooperate with the detents 72 provided adjacent the outer surface 66 of the main shaft 21 in the manner intended, and with reference to FIG. 11, each poppet assembly 96 is disposed at a location about the central body portion 50 of the swing arm 48 so that upon rotation of the swing arm 48 about the main shaft 21 to its second angular (FIG. 6) position, the longitudinal axis, indicated 102, of the barrel 82 of the poppet assembly 96 (which longitudinal axis 102 is oriented radially of the drum axis 17) is radially offset from the longitudinal axis 100 of the plug 76 (which longitudinal axis 100 is also oriented radially of the drum axis 17) so as to be disposed between the longitudinal axis 100 of the plug 76 and the engagement surface 80 against which the ball 90 is desired to act. In practice, the longitudinal axes 102 and 100 of the barrel 82 and plug 76, respectively, are spaced about one degree apart. Moreover, the engagement surface 80 is situated toward the side of the plug 76 opposite the radial direction in which the swing arm 48 is desired to be urged.

For purposes of understanding the direction of the spring-induced forces which act upon the main shaft 21, reference can be had to FIG. 12 which schematically depicts the swing arm 48 when rotated forwardly (i.e. in the direction of the arrows 104) about the main shaft 21 and into its second angular position. When the swing arm 48 is in its depicted FIG. 12 position, the force which is exerted upon each engagement surface 80 is represented by the force vector 106, and as can be seen in this FIG. 12 view, each force vector 106 includes a component force vector 108 which is directed radially inwardly of the swing arm 48 and another component force vector 110 which is directed tangentially of the swing arm 48 and in a direction which corresponds with the rotational direction about the main shaft 21 opposite the direction of rotation indicated by the arrows 104. It will be understood that it is the tangential force vectors 110 which collectively act upon the engagement surfaces 80 in a manner which continually urges the swing arm 48 to rotate relative to the main shaft 21 in a direction corresponding to the rotational direction indicated by the arrows 104.

It follows that in order to move the drum 20 from its FIG. 2 collapsed condition to its FIG. 1 expanded condition, air pressure is applied to the actuating means 26 to move the drive rod 18 axially along the main shaft 21 toward its extended position and in a manner which begins to rotate the swing arm 48 from its first angular (FIG. 5) position toward its second angular (FIG. 6) position at which the circumferential segments 40, 42 assume the desired fully-expanded positions. As the swing arm 48 is rotated in this manner and in the rotational direction indicated by the arrows 104 of FIGS. 11 and 12, the ball 90 of each poppet assembly 96 is disposed in a retracted condition within the corresponding barrel 82 and (as is depicted in phantom lines in FIG. 11) slidably moves along the outer surface 66 of the main shaft 21. Upon rotation of the swing arm 48 to its second angular position about the main shaft 21, the ball 90 engages and comes to rest against the engagement surface 80 of the indentation 78 so that the tangential force vectors 110 (FIG. 12) continue to bias the swing arm 48 about the shaft 21 in the rotational direction corresponding to the direction indicated by the arrows 104. It follows that the swing arm 48, by way of the mechanical assembly 70, and the main shaft 21 operate as cam and cam follower, respectively, as the spring-biased ball 90 bears against the engagement surface 80 of the plug indentation 78 to bias the swing arm 48 forwardly about the shaft 21.

Before using the drum 20 when in its FIG. 1 fully-expanded condition, the air pressure exerted upon the drive rod 18 by way of the actuating means 26 in order to move the swing arm 48 to its second (i.e. forward) angular position can be relieved, and upon relief of such pressure, the swing arm 48 continues to be urged about the main shaft 21 by the action of the poppet assemblies 96 against the engagement surfaces 80 in the direction of the FIG. 12 arrows 104. It will therefore be understood that the strength of the compression springs 92 is strong enough to both maintain the swing arm 48 in its FIG. 6 second angular position about the main shaft 21 and to continually urge the circumferential segments 40, 42 into the fully-expanded positions—even when no air pressure is exerted upon the drive rod 18 by way of the actuating means 26 to move and hold the swing arm 48 in its second angular position.

The advantages of the aforedescribed spring-induced biasing forces of the poppet assemblies 96 upon the main shaft 21 (by way of the engagement surfaces 80) can be appreciated when considering the possibility of wear of various components of the drum 20 which, without the poppet assemblies 96, could permit the circumferential segments 40, 42 to back off of the fully-expanded positions which the segments 40, 42 are desired to assume when the drum 20 is positioned in its FIG. 1 fully-expanded condition and the air pressure which has been exerted upon the drive rod 18 in order to move the swing arm 48 to its second angular (FIG. 6) position thereabout is relieved. In other words and upon movement of the swing arm 48 to its second angular position about the main shaft 21, the poppet assemblies 96 of the depicted drum 20 act against the engagement surfaces 80 to continually urge the swing arm 48 radially about the main shaft 21 (i.e. in the direction of the arrows 104 of FIGS. 11 and 12) beyond its second angular position, even after air pressure which has previously been exerted upon the drive rod 18 to move the swing arm 48 to its second angular position is relieved, so that the circumferential segments 40, 42 are tightly maintained in the fully-expanded positions for use of the drum 20.

When it is desired to return the drum 20 from the FIG. 1 fully-expanded condition to the FIG. 2 collapsed condition, the air-powered actuating means 26 is appropriately actuated to move the drive rod 18 axially along the main shaft 21 (i.e. toward its retracted position) so that the circumferential segments 40, 42 are, by way of the roller cams 62, swing arm 48 and links 56, moved radially inwardly of the drum 20. It follows that the rotational biasing forces exerted between the swing arm 48 and the main shaft 21 by way of the poppet assemblies 96 are not so strong that the actuating means 26 cannot rotate the swing arm 48 (i.e. rearwardly) from its FIG. 6 second angular position toward the FIG. 5 first angular position.

In other words, by exerting a withdrawal, or retraction, force upon the drive rod 18 which exceeds, for example, the threshold value of the total forces represented by the tangentially-directed force vectors 110 of FIG. 12, the poppet assemblies 96 can no longer hold the swing arm 48 in its second angular position so that the swing arm 48 is forced to rotate (i.e. rearwardly) about the main shaft 21 in a rotational direction opposite that indicated by the FIG. 12 arrows 104. As the swing arm 48 begins to rotate about the main shaft 21 in this rearward rotational direction, the balls 90 of the poppet assemblies 96 are forced to retract within the barrels 82 as the balls 80 move out of engagement with the engagement surfaces 80 of the indentations 78 to thereafter permit the swing arm 48 to be rotated rearwardly about the main shaft 21 unobstructed by the poppet assemblies 96.

Within the depicted drum 20, the strength of the compression springs 92 are preferably strong enough to collectively exert a total force (represented by the tangentially-drected force vectors 110 of FIG. 12) of about 150 pounds per square inch (psi). However, the springs 92 can possess an alternative spring strength and, in fact, the biasing strength of the springs 92 can be conveniently altered by rotating, as necessary, each cap member 94 relative to its corresponding barrel 82 to adjust the position of the cap member 94 along the length of the barrel 82 and thereby increase or decrease, as desired, the length of the springs 92 as measured between the cap members 94 and the balls 90. In practice, the more internal wear that the internal componentry of the drum 20 might experience over time, the stronger the biasing force which might be desired to be applied against the engagement surface 80 of the indentations 78 by the springs 92.

It follows from the foregoing that a scheme has been described which, when incorporated within a tire-building drum 20 having a stationary main shaft 21 and a swing arm 48 rotatably positioned about the main shaft 21 for rotation with respect thereto between a first position and a second position to thereby effect the movement of circumferential segments 40, 42 of the drum 20 between collapsed positions and fully-expanded positions, is adapted to continually bias the circumferential segments 40, 42 beyond the fully-expanded positions when the swing arm 48 is rotated about the main shaft 21 to its second angular position. To this end, the scheme includes at least one mechanical assembly 70 which, when the swing arm 48 is positioned in its second angular position, acts between the swing arm 48 and the main shaft 21 for urging the swing arm 48 beyond, or past, its second angular position and thereby urge the circumferential segments 40, 42 beyond, or past, the fully-expanded positions. Since the movement of the circumferential segments 40, 42 from the collapsed condition of the drum 20 toward the expanded condition of the drum 20 is limited by the fully-expanded positions of the circumferential segments 40, 42, any wear of the transition componentry (e.g. the links 56) which exists between the circumferential segments 40, 42 and the swing arm 48 and which may otherwise prevent the circumferential segments 40, 42 from tightly fitting together when the swing arm 48 is moved to its second position is compensated for by the mechanical assembly 70.

In other words and as mentioned earlier, the movement of the swing arm 48 about the main shaft 21 from the first position thereabout in order to move the drum 20 to its fully-expanded condition is not halted until the circumferential segments 40, 42 tightly engage one another in the fully-expanded positions. Therefore, when the circumferential segments 40, 42 are disposed in the fully-expanded positions, the location of the engagement surface 80 engaged by the ball 90 of a mechanical assembly 70 is determined by the condition of wear of the drum components. If, for example, the drum components are not worn, the location at which the ball 90 engages the engagement surface 80 is denoted 81 in FIG. 11, but if the drum components are worn, the ball 90 will engage another location of the engagement surface 80, such as the location indication 81′ in FIG. 11, which is disposed closer to the central axis 114 of the plug 100 than is the surface location 81.

Furthermore and due to the spherical form of each ball 90, each ball 90 will normally engage the engagement surface 80 of the indentation 78 at a point. Thus, the degree of slope or the contour of the engagement surface 80 is not critical for the operation of this invention. It is only significant that the spring-induced forces of the mechanical assembly 70 act against the engagement surface 80 so as to induce the aforedescribed tangential forces which urge the swing arm 48 to rotate forwardly about the main shaft 21 and thereby urge the circumferential segments 40, 42 toward and into the fully-expanded positions (i.e. the positions assumed when the drum is in its FIG. 1 fully-expanded condition). Consequently, the engagement surface 80 may be defined along, for example, the surface of a concavity (as is the case with the depicted sloped engagement surface 80 of FIG. 11), along the surface of a plane, or along the edge of a corner.

Another advantage provided by the aforedescribed mechanical assemblies 70 and the detent-defining means 71 is that each of the assemblies 70 and the detent-defining means 71 is comprised of components which can be readily replaced if such components become damaged or worn.

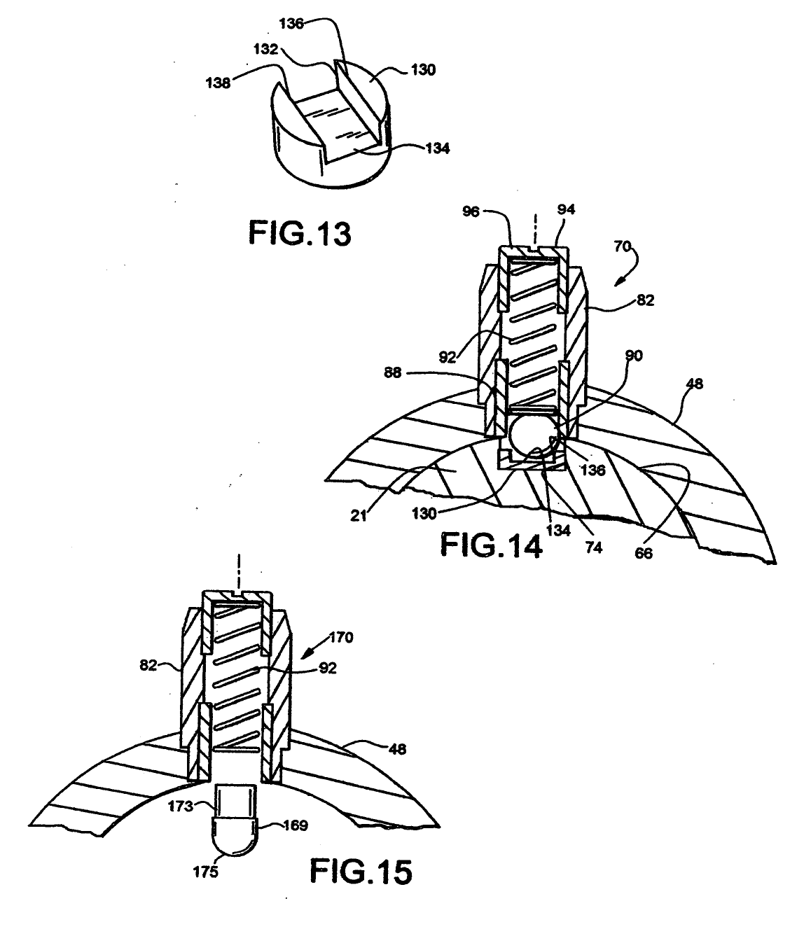

It will be understood that numerous modifications and substitutions can be had to the aforedescribed embodiment 20 without departing from the spirit of the invention. For example and as mentioned above, although the engagement surface 80 (i.e. the surface at which the ball 90 engages the indentation 78) of the aforedescribed mechanical assembly 70 has been shown and described as being provided by the surface of an indentation 78 of conical shape, the engagement surface can be provided by the corner of an edge. For example, there is illustrated in FIGS. 13 and 14 views of a plug 130 which is threadably securable within an internally-threaded opening 74 defined within the outer surface 66 of a main shaft 21, but whose indentation, indicated 132, is provided by a linear slot 134 which extends across the upper surface of the plug 130 so as to provide a pair of linear corner edges 136, 138 adjacent the upper surface of the plug 130. When the plug 130 is threaded within the opening 74 for securement therein, care should be taken to orient one of linear corner edges (i.e. the corner edge 136) in a radial plan of the main shaft 21. The plug 130 is thereby in position to be acted upon by the mechanical assembly 70 so that the engagement surface of the depicted indentation 132 (i.e. the surface location at which the plug 130 is engaged, and thus acted upon, by the ball 130) is provided by the midpoint of the corner edge 134.

Furthermore and although the plunger mechanism 69 of the aforedescribed mechanical assembly 70 has been shown and described as being in the form of a ball 90, the plunger mechanism 69 can take an alternative form. For example, there is shown in FIG. 15 a mechanical assembly 170 having a spring-biased plunger mechanism 169 in the form of an elongated body 173 having a leading end (i.e. the indentation-engaging end) 175 which is substantially spherical in shape.

Accordingly, the aforedescribed embodiment 20 is intended for the purpose of illustration and not as limitation.

1. In a tire-building drum having a hollow main shaft having an end which is mountable upon a support for supporting the drum in a cantilevered condition above a floor, a plurality of circumferential segments about which a tire carcass can be constructed and which are movable between collapsed positions at which the drum is in a radially-collapsed condition and fully-expanded positions at which the drum is in a radially and fully-expanded condition, a drive rod which is positioned within and is axially movable along the length of the main shaft between a first condition and a second condition, and a swing arm which surrounds the main shaft and is connected between the circumferential segments and the drive rod so that axial movement of the drive rod along the length of the main shaft from the first condition to the second condition effects a rotation of the swing arm about the main shaft from a first position thereabout at which the drum is in its radially-collapsed condition to a second position at which the drum is in its radially and fully-expanded condition, the improvement comprising:
a mechanical assembly for acting between the swing arm and the main shaft so that upon rotation of the swing arm about the main shaft to its second position thereabout, the mechanical assembly biases the swing arm about the main shaft to continually urge the circumferential segments into the fully-expanded positions.

2. The improvement as defined in claim 1 further including an engagement surface against which the mechanical assembly is adapted to act, and wherein the mechanical assembly is mounted within one of the swing arm and the main shaft, and said engagement surface is associated with the other of the swing arm and the main shaft.

3. The improvement as defined in claim 2 wherein the main shaft includes an outer surface, and the improvement further comprises an indentation defined within the main shaft adjacent the outer surface thereof, and the indentation defines said engagement surface against which the mechanical assembly is adapted to act.

4. The improvement as defined in claim 3 wherein the mechanical assembly is mounted within the swing arm, the outer surface of the main shaft defines an opening therein, and the improvement further defines a plug having a body which is secured within the opening defined within the outer surface of the main shaft and the plug body defines an engagement surface against which the mechanical assembly is adapted to exert a force when the mechanical assembly acts between the swing arm and the main shaft as aforesaid.

5. The improvement as defined in claim 2 wherein the force exerted by the mechanical assembly upon the engagement surface includes a force component which is directed substantially tangentially of the main shaft so that the swing arm is biased about the main shaft as aforesaid.

6. The improvement as defined in claim 5 wherein the mechanical assembly includes a spring-biased plunger mechanism connected to the swing arm for acting against the engagement surface as aforesaid.

7. The improvement as defined in claim 6 wherein the plunger mechanism is in the form of a spherical ball.

8. The improvement as defined in claim 1 wherein the mechanical assembly is adapted to exert a force between the swing arm and the main shaft which urges the swing arm about the main shaft in a rotational direction thereabout which corresponds with the direction of rotation of the swing arm about the main shaft from its first position toward its second position.

9. The improvement as defined in claim 8 wherein the exerted force includes a force component which is directed substantially tangentially of the main shaft so that the swing arm is urged about the main shaft as aforesaid.

10. The improvement as defined in claim 9 wherein the mechanical assembly includes a spring-biased plunger mechanism for acting between the swing arm and the main shaft as aforesaid.

11. The improvement of claim 1 wherein axial movement of the drive rod along the length of the main shaft from the first condition to the second condition is effected by the application of an axial force to the drive rod, and the biasing strength of the mechanical assembly is large enough to continually urge the circumferential segments into the fully-expanded positions after the axial force which has been applied to the drive rod in order to move the drive rod axially along the main shaft to the second condition has been relieved.

12. The improvement of claim 1 wherein the main shaft defines an outer surface, and the improvement further comprises means defining a detent adjacent the outer surface of the main shaft, and the mechanical assembly cooperates with the detent defined by the detent-defining means so that upon rotation of the swing arm relative to the main shaft from the first position to the second position thereabout, the mechanical assembly biases the swing arm about the main shaft as aforesaid to thereby continually urge the circumferential segments into the fully-expanded positions.

13. The improvement as defined in claim 12 wherein the detent provides an engagement surface against which the mechanical assembly is adapted to act, and the mechanical assembly cooperates with the engagement surface of the detent as cam and cam follower to continually urge the swing arm about the main shaft in a rotational direction which corresponds with the direction of rotation of the swing arm about the main shaft from its first position thereabout toward its second position thereabout.

14. The improvement as defined in claim 13 wherein the mechanical assembly is mounted within the swing arm and includes a spring-biased plunger mechanism for acting upon the engagement surface so that upon rotation of the swing arm about the main shaft to the second position, the spring-biased plunger engages and bears against the engagement surface of the detent.

15. The improvement as defined in claim 12 wherein the outer surface of the main shaft defines an opening therein, the detent-defining means includes a plug which is positioned within the opening defined in the outer surface of the main shaft, and the engagement surface against which the mechanical assembly is adapted to act is provided by a surface of the plug.

16. The improvement as defined in claim 15 wherein the mechanical assembly includes an elongated barrel mounted within the swing arm so that the longitudinal axis of the barrel is oriented substantially radially of the main shaft and further includes a cap disposed at the end of the barrel opposite the main shaft, and the spring-biased plunger mechanism is positioned within the elongated barrel for acting between the cap and the engagement surface provided by a surface of the plug.

17. In a tire-building drum having a hollow main shaft having an end which is mountable upon a support for supporting the drum in a cantilevered condition above a floor, a plurality of circumferential segments about which a tire carcass can be constructed and which are movable between collapsed positions at which the drum is in a radially-collapsed condition and fully-expanded positions at which the drum is in a radially and fully-expanded condition, a drive rod which is positioned within and is axially movable along the length of the main shaft between a first condition and a second condition and so that the drive rod is movable from the first condition to the second condition upon application of an axial force applied thereto, and a swing arm which surrounds the main shaft and is connected between the circumferential segments and the drive rod so that axial movement of the drive rod along the length of the main shaft from the first condition to the second condition effects a rotation of the swing arm about the main shaft from a first position thereabout at which the drum is in its radially-collapsed condition to a second position at which the drum is in its radially and fully-expanded condition, the improvement comprising:
a mechanical assembly for acting between the swing arm and the main shaft so that upon rotation of the swing arm about the main shaft to its second position thereabout, the mechanical assembly biases the swing arm about the main shaft in a rotational direction with respect thereto which corresponds with the direction of rotation of the swing arm about the main shaft from its first position toward its second position to thereby continually urge the circumferential segments toward the fully-expanded positions, even after an axial force which has been applied to the drive rod for moving the drive rod axially along the length of the main shaft to the second position has been relieved.

18. The improvement as defined in claim 17 wherein the mechanical assembly is adapted to exert a force between the swing arm and the main shaft for biasing the swing arm about the main shaft as aforesaid and the exerted force includes a force component which is directed substantially tangentially of the main shaft for urging the swing arm about the main shaft as aforesaid.

19. The improvement as defined in claim 18 wherein the mechanical assembly includes a spring-biased plunger mechanism for acting between the swing arm and the main shaft as aforesaid.

20. In a tire-building drum having a hollow main shaft having an end which is mountable upon a support for supporting the drum in a cantilevered condition above a floor, a plurality of circumferential segments about which a tire carcass can be constructed and which are movable between collapsed positions at which the drum is in a radially-collapsed condition and fully-expanded positions at which the drum is in a radially and fully-expanded condition, a drive rod which is positioned within and is axially movable along the length of the main shaft between a first condition and a second condition and so that the drive rod is movable from the first condition to the second condition upon application of an axial force applied thereto, and a swing arm which surrounds the main shaft and is connected between the circumferential segments and the drive rod so that axial movement of the drive rod along the length of the main shaft from the first condition to the second condition effects a rotation of the swing arm about the main shaft between a first angular position thereabout at which the drum is in its radially-collapsed condition and a second angular position at which the drum is in its radially and fully-expanded condition, the improvement characterized in that:
the main shaft has an outer surface, and the drum includes means defining a detent adjacent the outer surface, and
the drum includes a mechanical assembly connected to the swing arm for acting between the detent of the detent-defining means and the swing arm so that upon rotation of the swing arm relative to the main shaft to the second angular position thereabout, the mechanical assembly cooperates with the detent as a cam and cam follower to bias the swing arm from its first angular position toward its second angular position to thereby continually urge the circumferential segments to the fully-expanded positions, even after the axial force which has been applied to the drive rod axially along the length of the main shaft for moving the swing arm to the second angular position has been relieved.
